(19) United States
(12) Patent Application Publication
(10) Pub. No.: US 2018/0006841 A1
(43) Pub. Date: Jan. 4, 2018

(54) WIND TURBINE, WIND TURBINE COMMUNICATION SYSTEM, AND METHOD FOR OPERATING A BUS SYSTEM

(71) Applicant: WOBBEN PROPERTIES GMBH, Aurich (DE)

(72) Inventors: Steffen FISCHER, Upgant-Schott (DE); Stefan RICHTER, Emden (DE)

(21) Appl. No.: 15/543,117

(22) PCT Filed: Jan. 21, 2016
(86) PCT No.: PCT/EP2016/051212

§ 371 Date: Jul. 12, 2017

(30) Foreign Application Priority Data
Jan. 22, 2015 (DE) 102015201019.8

(51) Int. Cl. H04L 12/40; H04L 12/46

(52) U.S. Cl. CPC H04L 12/40019; H04L 12/462; H04L 12/40143; H04L 2012/40215

(57) ABSTRACT

A wind turbine having a Controller Area Network communication system is provided. Electrical and/or electronic components of the wind turbine are coupled to CAN nodes. The communication system has a plurality of CAN nodes. At least one CAN distributor unit is coupled via a first communication segment to one of the plurality of CAN nodes and via a second communication segment to at least one further CAN distributing unit. The CAN distributor units are designed to carry out a data communication via the first communication segment on the basis of a first CAN protocol which represents a standard CAN protocol, and to carry out a data communication via a second communication segment on the basis of a second CAN protocol which is different from the standard CAN protocol.

### BACKGROUND

### Technical Field

The present invention relates to a wind turbine and a wind turbine communication system.

### Description of the Related Art

A wind turbine has a multiplicity of electrical and electronic components which must communicate with one another. This communication can be improved e.g., by providing a data bus, wherein the respective electrical or electronic components are connected to the data bus for data communication.

A data bus of this type may represent a CAN (Controller Area Network) bus which has been developed for use in the automotive sector, i.e., for shorter distances. The CAN bus must therefore be adapted for use in a wind turbine. The CAN bus is internationally standardized as ISO 11898. Mechanisms governing the bus use (arbitration) and transmission sequence (prioritization) are defined in ISO 11898.

US 2012/0193917 A1 shows a wind turbine with an internal communication bus which is implemented as a CAN bus. In the priority-establishing German patent application, the following documents have been cited by the German Patent and Trade Mark Office: DE 10 2007 011 835 A1; US 2014/0133350 A1; DE 101 00 343 A1 and DE 600 04 035 T2.

### BRIEF SUMMARY

An object is to provide a wind turbine, which enables improved communication of the electrical or electronic components within the wind turbine.

This object is achieved by a wind turbine described herein.

According to an embodiment, a wind turbine is provided with a Controller Area Network (CAN) communication system. The communication system has a plurality of CAN nodes which can communicate with one another via the communication system. The CAN nodes can be coupled to the electrical or electronic components of the wind turbine which must communicate with other components. The CAN communication system has a plurality of CAN distributor units which are coupled via first communication segments to the CAN nodes and via a second communication segment to a further CAN distributor unit. Data communication takes place via the first communication segment on the basis of a first CAN protocol which is based on the standard CAN protocol. Data communication takes place via the second communication segment on the basis of a second CAN protocol which differs from the standard protocol.

According to an embodiment, a CAN communication system is provided which, strictly speaking, does not enable a bus system, but rather a point-to-point connection or communication. The facility to modify or extend the CAN protocol can thereby be provided.

According to one embodiment, the second CAN protocol allows a delayed incoming acknowledge signal. This is enabled according to an embodiment in that the communication system ensures a point-to-point connection. The CAN distributing units are coupled, on the one hand, to CAN nodes and, on the other hand, to other CAN distributing units which in turn are coupled to CAN nodes. Communication from a first CAN node to a second CAN node thus takes place from the first CAN node to a first CAN distributing unit, from the latter to the second CAN distributing unit and from the second CAN distributing unit to the second CAN node. It can be ensured by means of these point-to-point connections that a plurality of CAN nodes do not access the connection simultaneously, as may occur in the case of a bus system.

According to an embodiment, the connection between a CAN node and a CAN distributor node is a direct point-to-point connection. The connection between two CAN distributor units which are coupled to one another by a second communication segment is similarly a point-to-point connection. The advantages according to the embodiment can be achieved by means of the point-to-point connections, wherein, in particular, communication can be enabled between two CAN nodes over a greater distance. The communication system according to the embodiment is furthermore advantageous in that each point-to-point connection or each line or segment in the communication system is individually verifiable, so that faults which occur can be reliably and precisely localized. According to an embodiment, the data communication baud rate can furthermore be set separately for each communication line or each point-to-point connection. Since the nodes that are coupled to the respective elements of the wind turbine represent CAN nodes, standardized modules can be used for the communication. The price for communication modules of this type is thus lower than in the case of dedicated communication modules.

The distributing units act as an interface and can communicate not only on the basis of a first CAN protocol but also on the basis of a second CAN protocol. The communication with the CAN nodes can be implemented on the basis of the first CAN protocol and the communication with other distributing units can be implemented via the second CAN protocol. The second CAN protocol enables a data communication over greater distances and at a higher speed than the first CAN protocol. The first CAN protocol may be based on the standard CAN protocol according to ISO 11898.

According to an embodiment, the first communication segment can be designed optionally as a CAN bus.

According to an embodiment, the communication bus or the communication system is implemented in the wind turbine as a CAN communication system and is further adapted to a wind turbine environment. It must be taken into account here, for example, that the tower of the wind turbine may reach a height of more than 100 m. Furthermore, the length of the rotor blades of the wind turbine, for example, may also exceed 50 m. In the communication system according to an embodiment, it must be ensured that a bus arbitration and a transmission sequence can also be maintained.

Due to the large size of the wind turbine and the different arrangement of the respective electrical or electronic units that are connected to the CAN communication system, situations may arise in which error frames are generated in the event of multiple access to the CAN communication system. This may occur due to an unfavorable interaction between the signal transit time in the large size of the CAN communication system and due to asynchronous access of a plurality of participants. This may occur, in particular, in the event of a random bundling of frames of different participants following the first frame of the bundle. The greater the size of the communication system, the more of these error frames can be generated. The number of error frames similarly increases with increasing utilization of the communication system.

According to an embodiment, a wind turbine is provided with a Controller Area Network (CAN) communication system. The system subdivides the communication structures of the CAN communication system into individual point-to-point connections. The CAN communication takes place for short communication segments in accordance with the ISO 11898 standard. A protocol which differs from the standard ISO 11898 protocol is used for long communication segments. Since a long point-to-point connection is created on the long communication segments, a simple adaptation of the standard CAN protocol (ISO 11898) can be carried out. The adapted protocol is downwardly compatible with the standard protocol according to ISO 11898 on each optical point-to-point connection.

The one long segment is designed optically according to one embodiment. The adapted protocol differs from the standard ISO 11898 protocol in that both involved CAN distributor units accept a delayed incoming acknowledge signal. A permissible delay is predefinable via the transit time of the CAN data reflected by the remote station. The explicit reflection of the CAN data is advantageous in optical transmission, since no coupling exists here between the transmit line and the receive line, in contrast to the standardized electrical connection. All CAN communication segments optically accessible on one of the CAN distributor units can, therefore, be designed as a long segment if the remote station supports the protocol extension. However, this does not function if the remote station is designed as a conventional CAN node.

A wind turbine is thus provided with a CAN communication system which has a plurality of CAN nodes which communicate with one another via the CAN communication system. The CAN communication system has a plurality of CAN distributor units which are coupled via a first communication segment to a CAN node and via a second communication segment to further CAN distributor units. Data communication based on a standard CAN protocol takes place via the first communication segment. Data communication takes place via the second communication segment on the basis of a protocol which differs from the standard CAN protocol.

According to one embodiment, the length of the second communication segment is substantially greater than the length of the first communication segment.

According to a further embodiment, the second communication segment is designed as an optical connection, i.e., data communication takes place optically via the second communication segment.

According to a further embodiment, the second CAN protocol allows a delayed incoming acknowledge signal. The permissible delay can be determined via the transit time of the CAN data reflected by a remote station.

According to an embodiment, a CAN communication system is provided which enables a virtual reduction of the “bus” size in order to enable higher baud rates in the data transmission. Furthermore, “bus” access is decoupled in order to avoid error frames. Furthermore, the utilization of the CAN nodes or CAN connections can be optimized. Individual baud rates for each CAN node can optionally be permitted. A further advantage is the isolated fault analysis of the individual bus segments. Cabling faults have hitherto always manifested themselves on the entire bus, thereby impeding fault diagnosis and adversely affecting availability.

According to an embodiment, a CAN distributor unit can be provided for this purpose which enables an automatic detection of the baud rate of the connected CAN node, a decoding of the CAN frame, a generation of an acknowledge signal, an encoding of the CAN frame and a receive and transmit buffer with at least one frame length.

The embodiments described herein relate to a wind turbine with a plurality of electrical or electronic units which communicate with one another via a CAN communication system. The CAN bus represents a serial fieldbus which is defined in ISO 11898.

According to one embodiment, the CAN bus can be designed as a multi-master bus in which each participant is allowed to use the bus independently according to a defined mechanism. The transmission takes place, insofar as it takes place electrically, via a twisted pair cable with a characteristic impedance of 95 to 140 ohms. The bus is accessed by means of an arbitration which operates according to the CSMA/CR (carrier sense multiple access/collision resolution) method. By means of this method, multiple access or potential collisions are resolved using a priority mechanism. The bit transmission speed is not defined in a fixed manner and can be determined by the size of the bus and the signal transmit times resulting therefrom. A frame-by-frame confirmation of receipt (acknowledge) can take place within a bit window (acknowledge slot). The data transmission on the CAN bus is defined according to the OSI (Open System Interconnection model) Layer 1 and 2. Due to the substantial difference in potential between the CAN nodes in the wind turbine, due to the physical size and strong noise fields, the CAN bus is preferably designed essentially as an optical CAN bus. Due to strong electrical and magnetic noise fields, an increased bit error rate can be expected, insofar as the transmission takes place electrically. A reduction in the bit transmission rate can be provided for this purpose.

Further designs are the subject-matter of the subclaims.

### BRIEF DESCRIPTION OF THE SEVERAL VIEWS OF THE DRAWINGS

Advantages and example embodiments are explained in detail below with reference to the drawing.

FIG. 1 shows a schematic representation of a wind turbine according to an embodiment,

FIG. 2 shows a schematic representation of a CAN bus in a wind turbine according to a first example embodiment,

FIG. 3 shows a schematic representation of a system architecture of a wind turbine according to the first example embodiment,

FIG. 4 shows a schematic block diagram of a section of a CAN communication system according to a first example embodiment,

FIG. 5 shows a schematic block diagram of a CAN distributor unit according to a third example embodiment,

FIG. 6 shows a block diagram of a baud rate and frame detection in a CAN distributing unit according to a fourth example embodiment,

FIG. 7 shows a schematic block diagram of a frame detection in a CAN distributing unit according to a fourth example embodiment,

FIG. 8 shows a schematic block diagram of a transmitting unit in a CAN distributing unit according to the fourth example embodiment,

FIG. 9 shows a block diagram of an error detection unit in a CAN distributing unit according to the fourth example embodiment, and

FIG. 10 shows a block diagram of a part of a CAN distributing unit according to a fifth example embodiment.

### DETAILED DESCRIPTION

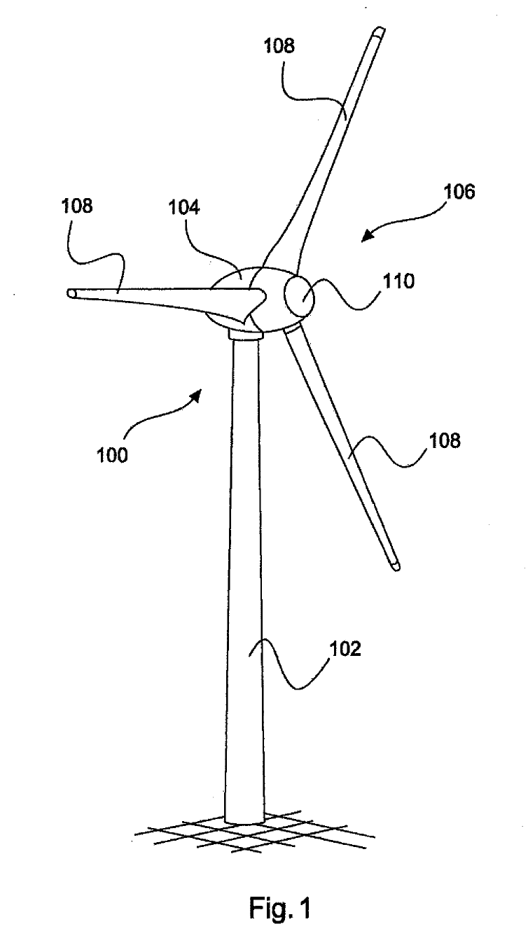

FIG. 1 shows a schematic representation of a wind turbine according to an embodiment. The wind turbine 100 has a tower 102 and a nacelle 104 on the tower 102. The tower 102 may have a plurality of tower segments which are placed on top of one another in order to form the tower 102. An aerodynamic rotor 106 with three rotor blades 108 and a spinner 110 is provided on the nacelle 104. During the operation of the wind turbine, the aerodynamic rotor 106 is set in rotational motion by the wind and therefore also rotates a rotor or winding of a generator which is directly or indirectly coupled to the aerodynamic rotor. The electrical generator is disposed in the nacelle 104 and generates electrical energy. A pitch angle of the rotor blades 108 can be modified by pitch motors on the rotor blade roots of the respective rotor blades.

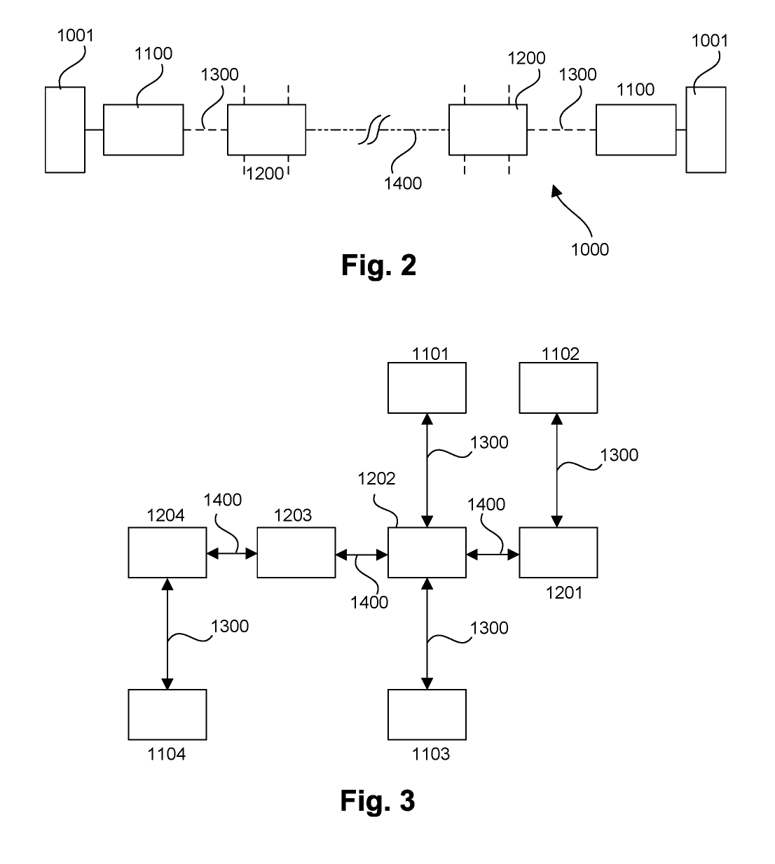

FIG. 2 shows a schematic representation of a CAN communication system in a wind turbine according to a first example embodiment. The communication system 1000 has a plurality of CAN nodes 1100 which are coupled via a first communication segment 1300 in each case with a CAN distributing unit 1200. The CAN nodes can be coupled to electrical or electronic components 1001 of the wind turbine 100. The respective CAN distributing units 1200 are coupled via a second communication segment 1400. The first communication segment 1300 is a communication segment with a short distance and may be designed as an electrical or optical communication segment. Communication between the CAN node 1100 and the CAN distributing unit 1200 can take place on the first communication segment via a first CAN protocol. The first CAN protocol may represent the standard CAN protocol according to ISO 11898. On the second communication segment 1400, which is preferably designed as an optical connection, data communication can take place according to a second CAN protocol which does not correspond to the standard protocol, but corresponds to a modified standard CAN protocol, in order to be able to use an increased/high data transmission rate despite the large size.

The communication system transmits data in the case of an electrical transmission via the differential transmission method between the respective participants. The system is operated in half-duplex mode, so that transmission can only ever take place in one direction on the line. In the case of an optical transmission, a transmission takes place via separate transmit (Tx) and receive powers (Rx). The transmitter monitors the bus in order to verify transmitted data and in order to detect whether a different participant with a higher priority is placing a frame on the bus. As soon as a frame with a higher priority is present on the bus, the participant wishing to transmit must hold back its data and accept the data of the other participant with the higher-priority frame. Each of the CAN nodes as a participant can hold back its data until the bus is free and no participant is placing a frame with a higher priority on the bus. This applies to the communication in the first communication segment between the CAN nodes and the CAN distributor unit. The first communication segment may be designed as a CAN bus.

FIG. 3 shows a schematic representation of a system architecture of a wind turbine according to the first example embodiment. FIG. 3 shows a CAN distributing unit 1201 for a tower of the wind turbine, a CAN distributing unit 1202 for a nacelle of the wind turbine, a CAN distributing unit 1203 as an optical distributor of the nacelle of the wind turbine and a CAN distributing unit 1204 as an optical distributor for the rotor of the wind turbine. Communication takes place between the respective CAN distributing units 1201-1204 via the second communication segment 1400 and therefore according to a second CAN protocol. A control unit 1102 for the tower can be coupled to the CAN distributing unit for the tower 1201 via a first communication segment 1300. A control unit 1101 for the nacelle can be coupled to the CAN distributing unit 1202 for the nacelle via a first communication segment 1300. A rectifier control unit 1103 can be coupled to the CAN distributing unit for the nacelle 1202 via a first communication segment 1300. According to an embodiment, all frames transmitted by the units connected to the CAN communication system are forwarded via one of the CAN distributing units. The CAN distributing units are thus responsible not only for the communication with other CAN distributing units but also for the communication with the control units connected directly to the respective CAN distributing unit.

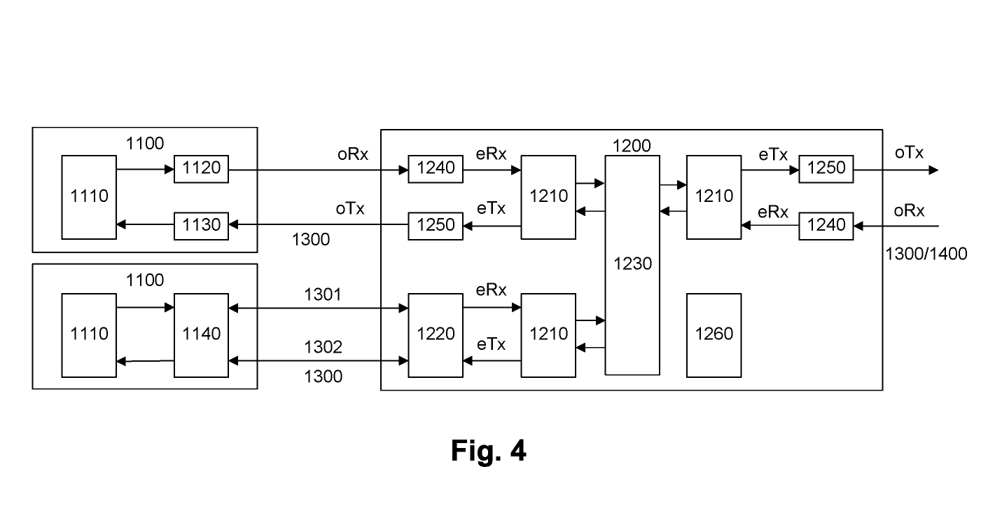

FIG. 4 shows a schematic block diagram of a section of a CAN communication system according to a first example embodiment. A CAN node 1100 is coupled via a first CAN communication segment 1300 to a CAN distributing unit 1200. The first communication segment 1300 may have a transmit line Tx and receive line Rx. The CAN node 1100 may have a CAN node controller 1110, an electrical transceiver 1140 or an (optical) transmitter 1120 and an (optical) receiver 1130. The CAN distributing unit 1200 may have an interface unit 1210, e.g., with an electrical transceiver 1220 with an (optical) receiver 1240 and an (optical) transmitter 1220. Furthermore, the CAN distributing unit 1200 has a switching unit 1230 and an error detection and processing unit 1260. An automatic detection of the baud rate of the connected CAN nodes 1100, a decoding of the CAN frames, a generation of an acknowledge signal, an encoding of the CAN frames, a generation of an acknowledge signal, an encoding of the CAN frames and a receive and transmit buffer with at least one frame length can be provided with the CAN distributing unit 1210 according to an embodiment, which can serve as an input stage.

The CAN node 1100 may have a CAN node controller 1110 and either an electrical transceiver 1140 or, alternatively, an optical transmitter 1120 and an optical receiver 1130. The CAN node 1100 may, therefore, have either an optical transceiver module or an electrical transceiver module. The optical transmitter 1120 and the optical receiver 1130 communicate with the optical receiver 1240 and the optical transmitter 1220 of the CAN distributor unit 1200. The electrical transceiver 1140 of the CAN node 1100 communicates via the electrical lines 1301, 1302 with the electrical transceiver 1220 in the CAN distributor unit 1200. The optical receiver 1240 and the optical transmitter 1250 communicate via an electrical receive line eRx and an electrical transmit line eTx with the interface unit 1210.

The electrical transceiver 1220 communicates accordingly via an electrical receive line eRx and an electrical transmit line eTx with an interface unit 1210.

A communication according to the second CAN protocol can take place if a CAN distributor unit which enables communication according to the second CAN protocol is similarly provided in the remote station.

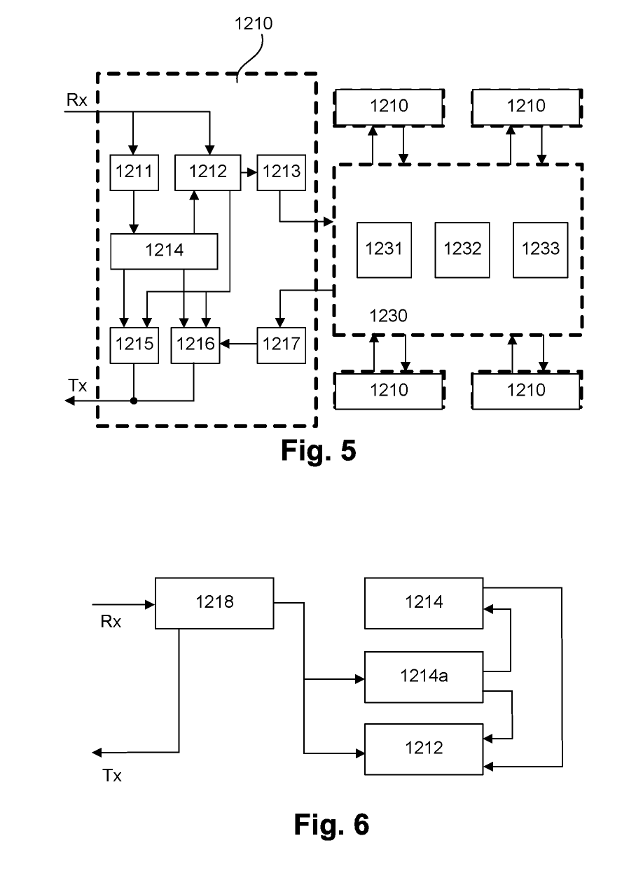

FIG. 5 shows a schematic block diagram of a CAN distributor unit according to a third example embodiment. The transmitter and receiver can also be integrated in an interface unit 1210 at the input and/or output of the CAN distributing unit 1200. A corresponding interface input unit 1210 may have an edge detector 1211, a frame detector 1212, a transmit buffer 1213, a baud rate generator 1214, an acknowledge generator 1215, a frame encoder 1216 and a transmit buffer 1217. The switching unit 1230 may have a priority control unit 1231, a state control unit 1232 and flow control unit 1233.

The interface 1210 may have a frame detection unit 1212, a baud rate detection unit 1214a, a baud rate generator 1214, an arbitration unit 1218 and a transmit buffer and a transmission control unit 1219. According to an embodiment, a decentralized approach to the administration of the interfaces is provided. The input frames detected by the frame detection unit 1212 are copied directly into the transmit buffer 1219. The priority of the frames can be determined in the transmit buffer 1219 and can be communicated to the correspondingly connected participants. A subsequently transmitted frame is transmitted only if an acknowledgement signal has been sent. A buffer in which a complete frame can be accommodated suffices as an input buffer. The input unit can operate more quickly since the received frames are forwarded directly to the transmit buffer. In the transmission control unit 1219, an identifier can be read in the frame in order to determine the priority of the frame.

FIG. 6 shows a block diagram of a baud rate and frame detection in a CAN distributing unit according to a second example embodiment. Only the clock pulse processing and clock pulse distribution are shown in FIG. 6. The data flow has largely been abstracted. An incoming signal is analyzed in the baud rate detection unit 1214a. A new clock pulse is synthesized in the baud rate generator 1214 on the basis of the analysis result. A frame detection unit 1212 is controlled with the synthesized clock pulse. An input frame is fed to the arbitration unit 1218. The input frames are detected in the frame detection unit 1212. The baud rate of the frame is determined in the baud rate detection unit 1214a. In particular, the baud rate on the second segment of the bus, i.e., for example, on the optical connection, can be determined in the baud rate detection unit 1214a. Two clock pulses are generated in the baud rate generator 1212 for the sampling of the receive line and the transmit line. Once the baud rate has been detected and the clock pulse has been generated, the frame detection unit 1212 can be activated in order to define the useful data of the frame using the baud clock.

If the frame has been successfully detected, the transmitter can then transmit an acknowledgement signal in order to mark the frame as a valid frame. This information can then be forwarded to the connected participants.

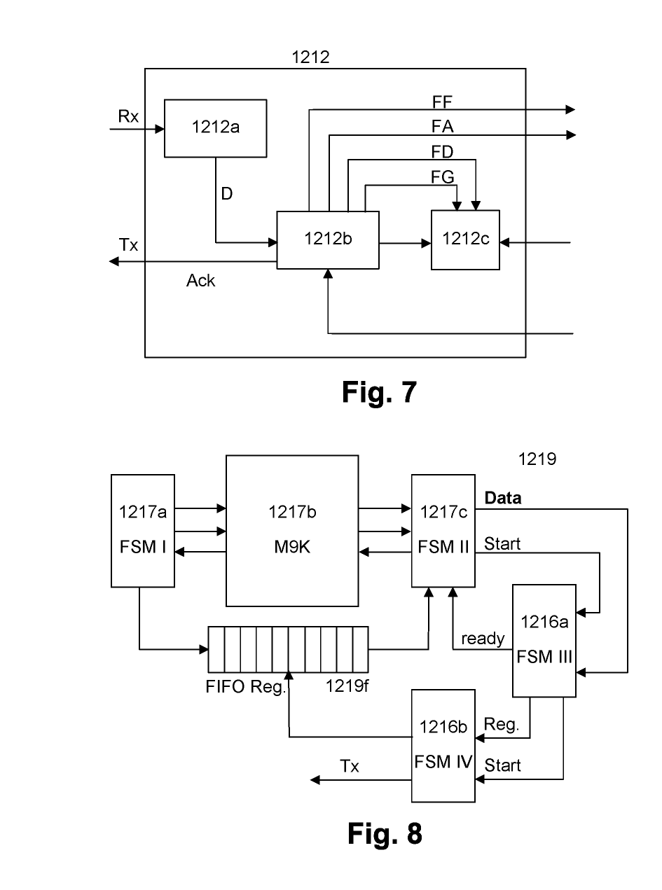

FIG. 7 shows a schematic block diagram of a frame detection in a CAN distributing unit according to a second example embodiment. The frame detection unit 1212 has a stuff bit filter 1212a, a first state machine 1212b and a second state machine 1212c. The frames are received via the input line Rx and an acknowledge signal Ack can be transmitted via a transmit line Tx if a frame has been successfully received. The frame detection unit 1212 according to an embodiment can detect frames not only according to CAN 2.0A, but also according to CAN 2.0B. The stuff bit filter 1212a is provided for the stuff bits present in the data stream. The frame detection can be designed to be more simple by removing these stuff bits before the frame detection is started. The frame detection unit 1212 is furthermore designed to forward the detected frames to further connections. This is done by the second state machine and an internal bus which is provided between the frame detection unit 1212 and the receive buffer 1213. As an output signal, the first state machine 1212b may have a frame error FE, an active frame FA, frame data FD and a valid frame FG which have been transmitted from the first to the second state machine. The frame error FE and frame active FA output signals can be output.

FIG. 8 shows a schematic block diagram of a transmitting unit in a CAN distributing unit according to the third example embodiment. The state machine FSM I of the transmitting unit 1219 receives the frames distributed by the switching unit 1230 and can sort the frames according to their priority. The received frames can be stored temporarily in the buffer 1217b. The First-In-First-Out memory 1217d serves to administer the frames in the memory 1217b. The state machine FSM II 1217c checks which frame has the highest priority and transmits the frame with the highest priority to the output state machine FSM III 1216a. The state machine FSM IV monitors the transmission process and deletes the frame from the buffer 1217d if the process is successful. Otherwise, the transmission process can be repeated. The state machine 1219a receives the data from the frame detection unit 1212 and can store the data temporarily in the buffer 1219b. A further state machine 1219c determines the priority of the frames stored in the buffer 1219b and reads the frames with the highest priority from the buffer 1219b. The state machine 1219d is responsible for ensuring that the frame extracted from the buffer is transmitted.

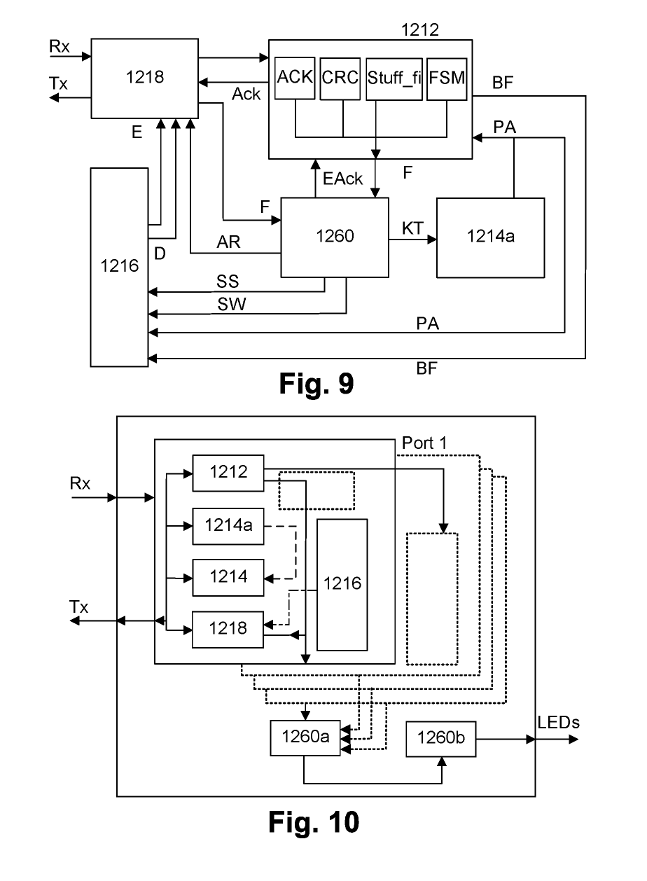

FIG. 9 shows a block diagram of an error detection unit in a CAN distributing unit according to the fourth example embodiment. In particular, the detection and handling of errors in the CAN distributing unit will be explained below. The arbitration unit 1218 receives frames from the receive line Rx. These data are forwarded to the frame detection unit 1212 which transmits an acknowledge signal Ack back to the arbitration unit 1218. The frames are detected in the frame detection unit 1212 and, if an error F is present, this is transmitted to the error unit 1218a. The error unit 1218a then transmits a no-acknowledge signal kAck to the frame detection unit 1212, with which a transmission of an acknowledge signal Ack is prevented. The error unit 1218a then transmits the information “no participant” kT to the baud rate detection which transmits a port disable signal PA to the frame detection unit 1212 and to the transmitting unit 1219. The error unit 1218k furthermore transmits a stop transmission signal SS or a repeat transmission signal SW. Possible errors include bit errors, stuff bit errors, CRC errors, form errors or acknowledgement errors. A bit error which occurs during the arbitration is detected in the arbitration unit 1218 and this information is forwarded to the error unit 1218a. As a result, the error unit 1218a aborts a transmission process. If frames are currently being received, the error unit 1218a ensures that a no-acknowledge signal kAck is transmitted back. If errors occur in the CRD sums, this can be forwarded from the frame detection unit 1212 to the error unit 1218.

FIG. 10 shows a block diagram of a part of a CAN distributing unit according to a fifth example embodiment. According to one example embodiment, a frame detection unit 1212, a baud rate detection unit 1214a, a baud rate generator 1214, an arbitration unit 1218 and a transmission control unit 1219 are provided. Furthermore, an error unit 1218a and an LED control unit 1218b can be provided.

1. A wind turbine, comprising:
at least one electrical or electronic component;
a Controller Area Network communication system having a plurality of CAN nodes and a plurality of CAN distributing units, a first CAN distributing unit of the plurality of CAN distributing units is coupled via a first communication segment to one of the plurality of CAN nodes and via a second communication segment to at least a second CAN distributing unit of the plurality of CAN distributing units,
wherein the plurality of CAN nodes are coupled to the at least one electrical or electronic component,
wherein the plurality of CAN distributor units are configured to carry out a data communication via the first communication segment based on a first CAN protocol that is a standard CAN protocol,
wherein the plurality of CAN distributor units are configured to carry out a data communication via the second communication segment based on a second CAN protocol that is different from the standard CAN protocol.

2. The wind turbine according to claim 1, wherein the second communication segment is an optical line.

3. The wind turbine according to claim 1, wherein the second communication segment is point-to-point connection.

4. The wind turbine according to claim 1, wherein a CAN distributing unit is provided at both ends of the second communication segment.

5. The wind turbine according to claim 1, wherein a length of the second communication segment is greater than a length of the first communication segment.

6. The wind turbine according to claim 1, wherein each CAN distributing unit of the plurality of CAN distributing units has a CAN interface for communication with the CAN nodes.

7. The wind turbine according to claim 6, wherein the CAN interface includes a frame detection unit, a baud rate detection unit, a baud rate generator and an arbitration unit.

8. A wind turbine communication system, comprising:
a plurality of CAN nodes which are coupled to at least one electrical or electronic component of a wind turbine, and
a plurality of CAN distributing units, a first CAN distributing unit of the plurality of CAN distributing units is coupled via a first communication segment to a CAN node of the plurality of CAN nodes and via a second communication segment to a second CAN distributing unit of the plurality of CAN distributing units,
wherein a data communication takes place via the first communication segment based on a first CAN protocol that is a standard CAN protocol,
wherein a data communication takes place via the second communication segment based on a second CAN protocol which is different from the standard CAN protocol.

9. A method for communication between at least two electrical or electronic components of a wind turbine that are coupled to a CAN node, wherein the wind turbine has a communication system with a plurality of CAN nodes and a plurality of CAN distributor units, the method comprising:
communicating, by a first CAN distributor unit of the plurality of CAN distributor units, via a first communication segment with one of the plurality of the CAN nodes,
communicating, by the first CAN distributor unit of the plurality of CAN distributor units, via a second communication segment with a second CAN distributor unit of the plurality of CAN distributor units,
wherein communicating via the first communication segment is made using a first CAN protocol which corresponds to a standard CAN protocol, and
wherein communicating via the second communication segment is made using a second CAN protocol which differs from the standard CAN protocol.

10. The wind turbine communication system according to claim 8, wherein the second communication segment is an optical line.

11. The wind turbine communication system according to claim 8, wherein the second communication segment is a point-to-point connection.

12. The wind turbine communication system according to claim 8, wherein a CAN distributing unit is provided at both ends of the second communication segment.

13. The wind turbine communication system according to claim 8, wherein a length of the second communication segment is greater than a length of the first communication segment.

14. The wind turbine communication system according to claim 8, wherein each CAN distributing unit of the plurality of CAN distributing units has a CAN interface for communication with the CAN nodes.

15. The wind turbine communication system according to claim 14, wherein the CAN interface includes a frame detection unit, a baud rate detection unit, a baud rate generator and an arbitration unit.

16. The method according to claim 9, wherein the second communication segment is an optical line.

17. The method according to claim 9, wherein the second communication segment is a point-to-point connection.

18. The method according to claim 9, wherein a CAN distributing unit is provided at both ends of the second communication segment.

19. The method according to claim 9, wherein a length of the second communication segment is greater than a length of the first communication segment.

20. The method according to claim 9, wherein each CAN distributing unit of the plurality of CAN distributing units has a CAN interface for communication with the CAN nodes.
